(19) United States
(12) Patent Application Publication
(10) Pub. No.: US 2014/0366366 A1
(43) Pub. Date: Dec. 18, 2014

(54) METHOD FOR MANUFACTURING BATTERY TERMINAL PLATE

(71) Applicants: Tae In Kang, Incheon (KR); Young Su Kim, Jeollabuk-do (KR)

(72) Inventors: Tae In Kang, Incheon (KR); Young Su Kim, Jeollabuk-do (KR)

(21) Appl. No.: 14/360,575

(22) PCT Filed: Jan. 9, 2013
(86) PCT No.: PCT/KR2013/000153

§ 371 Date: May 23, 2014

(30) Foreign Application Priority Data
Jan. 31, 2012 (KR) 10-2012-0009447

(51) Int. Cl. H01M 2/30

(52) U.S. Cl. CPC H01M 2/30; H01M 2220/20
USPC 29/623.1

(57) ABSTRACT

A method of manufacturing a battery terminal plate includes primarily pressing a single processing material corresponding to a volume body into a semi-product having an asymmetric shape through a press cutting unit; gripping the semi-product and feeding the semi-product to a first processing unit by a pickup unit; asymmetrically pressing the semi-product by a first punch to primarily forge the semi-product into a volume body part and a plate part; pressing the semi-product located in the first processing unit by a second punch to secondarily forge the semi-product while forming a detailed structure at the volume body part and the plate part; pressing the semi-product with a pressure stronger than that in the second forging step by a third punch to tertiary forge the semi-product; and punching the semi-product by a cutting/trimming unit to removing the pickup gripping member and cutting an outer peripheral portion into a final product.

### TECHNICAL FIELD

The present invention relates to a method for manufacturing a battery terminal plate, and more particularly to a method of manufacturing a battery terminal plate by which a product is finished by processing an object, for example, a battery terminal plate for an electric vehicle, which has an asymmetric basic shape, in stages.

### BACKGROUND ART

As environmental regulations become strict, future competitiveness of the vehicle industry depends on development of eco-friendly vehicles. Eco-friendly vehicles having boomed already since the 1990s were commercialized and developed first under the name of hybrid cars.

Moreover, because interest in eco-friendly vehicles has doubled due to high oil prices and environmental problems in recent years, the Hybrid Electric Vehicle (HEV) market is expected to grow by 60% or more every year and the purchasing power of the market of the eco-friendly vehicles is expected to increase further.

As can be inferred from the term ‘hybrid’, the hybrid electric vehicles are complex vehicles to which a internal combustion engine and an electric motor are mounted together, and the hybrid electric vehicle is started by an electric motor and is driven by the electric motor at a low speed until the vehicle travels at a predetermined speed, and is accelerated by an engine while the electric motor is operated as auxiliary power to increase the acceleration of the vehicle. Meanwhile, when the vehicle is decelerated, a generator is rotated by an inertial force of the vehicle such that kinetic energy is converted into electric energy and is stored in a battery.

Meanwhile, (dedicated) electric vehicles which are driven by a motor rotated by a force of electric power charged in a battery have already been developed.

Batteries mounted to the hybrid electric vehicle and the electric vehicle are batteries charged by electric power generated through electrolysis generated at a positive electrode and a negative electrode. That is, the battery is a secondary lithium ion battery in which two electrodes of a positive electrode (copper) and a negative electrode (aluminum) are immersed in a solution containing positive ions and negative ions while being separated from each other.

Then, the deformed material may be an electrode (an active material), may be a substance in a solution, and may be dissolved in a solution. Currents (that is, electrons) enter a negative electrode, and materials charged with positive charges in a solution are moved to the electrode and coupled to the electrons to be changed into neutral elements or molecules. The substances charged with negative charges in the solution are moved to the positive electrode and lose electrons to be changed into neutral elements or molecules. If the changed material is an electrode, the electrode generally loses electrons and is dissolved in the solution.

Here, the positive electrode and the negative electrode are laser-welded to a terminal screw-coupled to a cap plate which blocks an opening part of a can (housing) and is accommodated in the can.

Then, the terminal is a single body which is a connecting terminal into which two electrodes are inserted to be fixed on one side thereof and an opposite surface of the terminal is coupled to a nut to be fixed to a battery can, and a screw part provided to an end connected to an external wire is provided as a single body. Then, the two terminals and the connecting terminal part of the terminal are coupled to each other through laser welding.

The battery terminal is assembled in a separate battery terminal plate to foe used, and in a method of manufacturing a battery terminal plate according to the related art, a processing material having a volume body is moved to several press machines or several forging machines to be formed into a basic shape through a plurality of pressing or forging processes, and is finished by cutting off an unnecessary portion and processing a surface of the processing material.

However, in the method of manufacturing a battery terminal plate using a press machine according to the related art, because a processing material continuously supplied in the form of a wire is cut to a predetermined length and the cut processing material is processed while moving to several press machines, a movement path of the processing unit as well as the processing material becomes longer, lowering productivity.

In the case of pressing according to the related art, metal chips or wastes of a product, that is, scraps which are iron chips are generated when a metal product is manufactured of a processing material, and when a cutting surface or a cutting line, that is, a processing material is to be cut by lowering a mold of a cutter, the processing material is completely cut by a descending pressure of the mold at a point where a ½ part of the processing material is cut such that a rough surface or a band shaped rough line is generated in the torn form at a part of the cut surface. This is as shown in FIG. 1.

However, in the method of manufacturing a battery terminal plate using a forging machine according to the related art, because a processing material continuously supplied in the form of a wire is cut to a predetermined length and the cut processing material is processed while moving to several forging machines, a movement path of the processing unit as well as the processing material becomes longer, lowering productivity.

Further, in the forging according to the related art, because a processing material is processed while being spread out, when a processing material is processed into an asymmetric shape, for example, such that one side thereof is thick and an opposite side thereof is steppe to be thin, the processing material may fail to be processed into a predetermined shape or may not be processed depending on a size thereof.

### DETAILED DESCRIPTION OF THE INVENTION

### Technical Problem

The present invention has been made in an effort to solve the above-described problems, and it is an object of the present invention to provide a method of manufacturing a battery terminal plate by which a processing material, for example, a battery terminal plate for an electric vehicle, whose basic shape is asymmetrical, is processed by stages to be manufactured into a final product.

### Technical Solution

In accordance with an aspect of the present invention, there is provided a method of manufacturing a battery terminal plate, the method including: a preliminary processing step S1 of primarily pressing a single processing material G corresponding to a volume body into a semi-product G-1 having an asymmetric shape through a press cutting unit 110; a semi-product introducing step S2 of gripping the semi-product G-1 continuously supplied after being primarily processed and feeding the semi-product G-1 to a first processing unit 130 by a pickup unit 120; a first forging step S3 of asymmetrically pressing the semi-product G-1 introduced into the first processing unit 130 by a first punch 161 to primarily forge the semi-product G-1 into a volume body part and a plate part; a second forging step S4 of pressing the semi-product G-1 located in the first processing unit 130 by a second punch 162 performing a pressing operation while interlocking with the first punch 161 to secondarily forge the semi-product G-1 while forming a detailed structure at the volume body part and the plate part; a third forging step S5 of, in a state in which the secondarily forged semi-product G-1 is located in the first processing unit 130 or is moved from the first processing unit 130 to the second processing unit 140, pressing the semi-product G-1 with a pressure stronger than that in the second forging step by a third punch 163 to tertiary forge the semi-product G-1 such that a cutting surface or a cutting line at an edge of the semi-product G-1 is pressed; and a trimming step S6 of, in a state in which the semi-product G-1 is located in the second processing unit 140 or moved to the third processing unit 150, punching the semi-product G-1 by a cutting/trimming unit 170 performing an elevation pressing operation to trim the remaining cutting surface or cutting line and an outer peripheral portion according to a design size such that the semi-product G-1 is processed into a final product G-2.

### Advantageous Effects

According to the present invention, when a processing material, that is, a battery terminal plate for an electric vehicle is processed, a single processing material having a volume body is processed by stages while performing both pressing and forging to manufacture a final product, so that a cutting surface or a cutting line generated in the pressing process is removed and an asymmetric forming operation which is difficult or impossible in the forging process can be allowed.

### BRIEF DESCRIPTION OF THE DRAWINGS

FIGS. 1 and 2 are schematic views showing a processed state (in which a cutting surface or a cutting line is formed) of a battery terminal for an electric vehicle according to the related art.

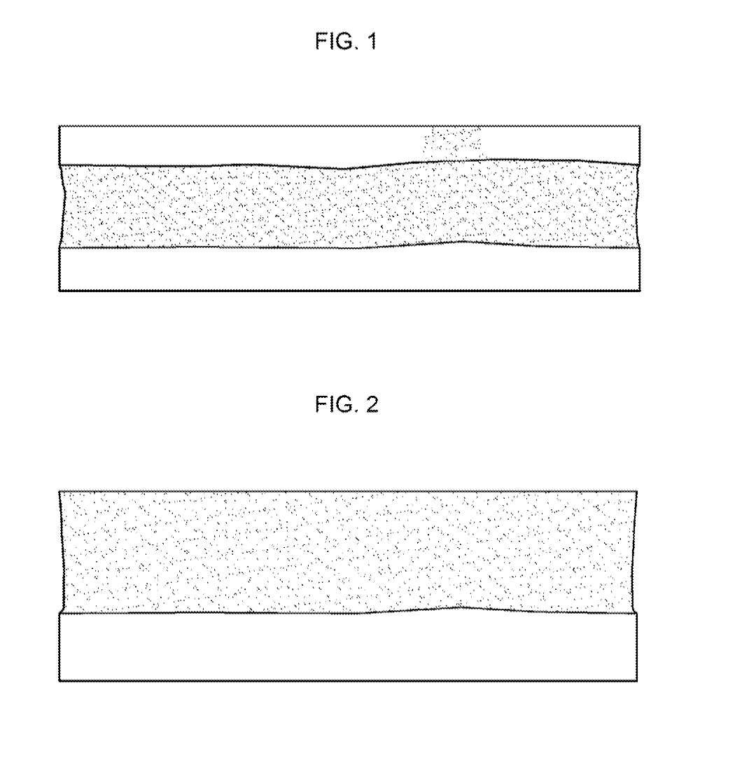

FIG. 3 is a block diagram schematically showing a manufacturing method according to an embodiment of the present invention by stages.

FIG. 4 is a schematic view showing a preliminary processing step and an operation thereof according to an embodiment of the present invention.

FIG. 5 is a schematic view showing a semi-product introducing step and an operation thereof according to an embodiment of the present invention.

FIG. 6 is a schematic view showing a first forging step and an operation thereof according to an embodiment of the present invention.

FIG. 7 is a schematic view showing a secondary forming step and an operation thereof according to an embodiment of the present invention.

FIGS. 8 and 9 are schematic views showing a tertiary forming step and an operation thereof according to an embodiment of the present invention.

FIG. 10 is a schematic view showing a fourth forming step and an operation thereof according to an embodiment of the present invention.

FIG. 11 is a perspective view showing an example of a battery terminal plate finished according to the present invention.

FIG. 12 is a perspective view showing an example of a battery terminal plate finally finished according to the present invention.

### MODE FOR CARRYING OUT THE INVENTION

Hereinafter, the present invention will be described with reference to the accompanying drawings.

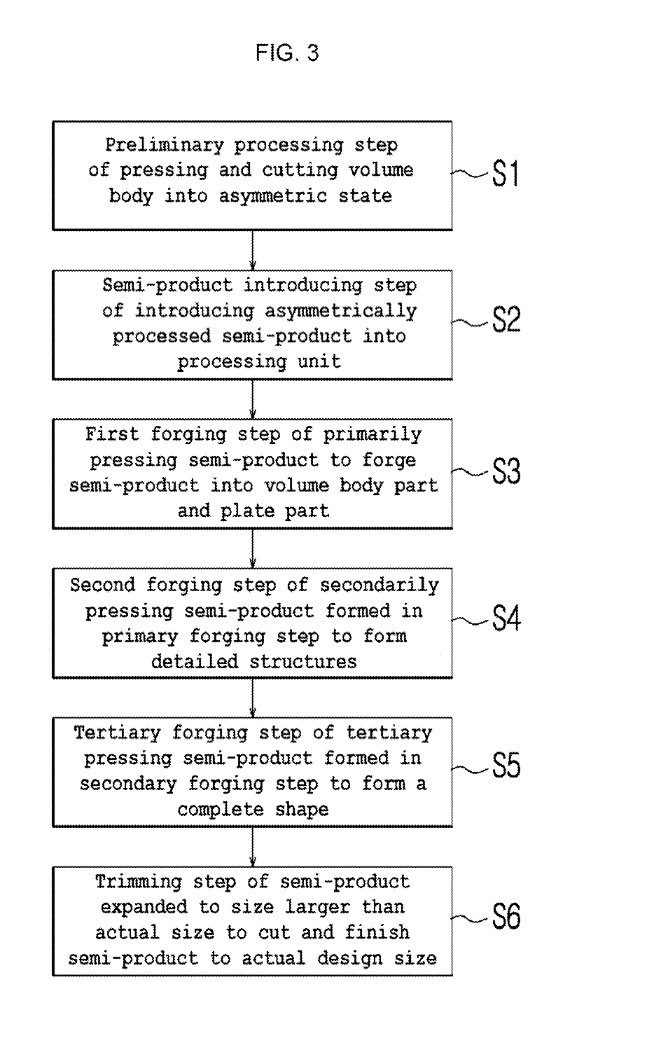

First, as shown in FIG. 3, the present invention includes: a preliminary processing step S1 of primarily pressing a single processing material G corresponding to a volume body into a semi-product G-1 having an asymmetric shape through a press cutting unit 110; a semi-product introducing step S2 of gripping the semi-product G-1 continuously supplied after being primarily processed and feeding the semi-product G-1 to a first processing unit 130 by a pickup unit 120; a first forging step S3 of asymmetrically pressing the semi-product G-1 introduced into the first processing unit 130 by a first punch 161 to primarily forge the semi-product G-1 into a volume body part and a plate part; a second forging step S4 of pressing the semi-product G-1 located in the first processing unit 130 by a second punch 162 performing a pressing operation while interlocking with the first punch 161 to secondarily forge the semi-product G-1 while forming a detailed structure at the volume body part and the plate part; a third forging step S5 of, in a state in which the secondarily forged semi-product G-1 is located in the first processing unit 130 or is moved from the first processing unit 130 to the second processing unit 140, pressing the semi-product G-1 with a pressure stronger than that in the second forging step by a third punch 163 to tertiary forge the semi-product G-1 such that a cutting surface or a cutting line at an edge of the semi-product G-1 is pressed; and a trimming step S6 of, in a state in which the semi-product G-1 is located in the second processing unit 140 or moved to the third processing unit 150, punching the semi-product G-1 by a cutting/trimming unit 170 performing an elevation pressing operation to trim the remaining cutting surface or cutting line and an outer peripheral portion according to a design size such that the semi-product G-1 is processed into a final product G-2.

For reference, of the units for performing the manufacturing method according to the present invention, that is, the manufacturing steps, the first processing unit 130 and the second, processing unit 140 or the first processing unit 130, the second processing unit 140, and the third processing unit 150 may be fixed molds located on the upper and lower sides or the left and right sides by a predetermined separation, the first and second punches 161 and 162 constituting the forming unit 160 or the first, second, and third punches 161, 162, and 163 are fixed by one fixed body such that the processing material G and the semi-product G-1 may be pressed to the first processing unit 130 and the second processing unit 140 or the first processing unit 130, the second processing unit 140, and the third processing unit 150 by one pressing driving unit (not shown), or the semi-product G-1 may be moved to change a forming location by a separate feeding unit (not shown).

Then, the molds are provided with pushing members (pins provided in the processing units to linearly reciprocate toward the processing material G and the semi-product G-1) operated by a separate driving unit at centers thereof such that the processing material 1 may be pushed to be separated from the molds, and the configuration may be a general one.

The first, second, and third punches 161, 162, and 163 may be pressing/forging units provided with a pressing body (a mold body located at a tip end of an external housing) at a tip end of the external housing.

In this case, the pressing driving units and the movement driving units of the first, second, and third punches 161, 162, and 163 may be cylinders operated by pistons, but any driving unit which linearly reciprocates will be sufficient.

In this case, the pushing member also may be driven by a cylinder, and may be driven by another unit which linearly reciprocates.

Next, the manufacturing method according to the present invention will be described by stages.

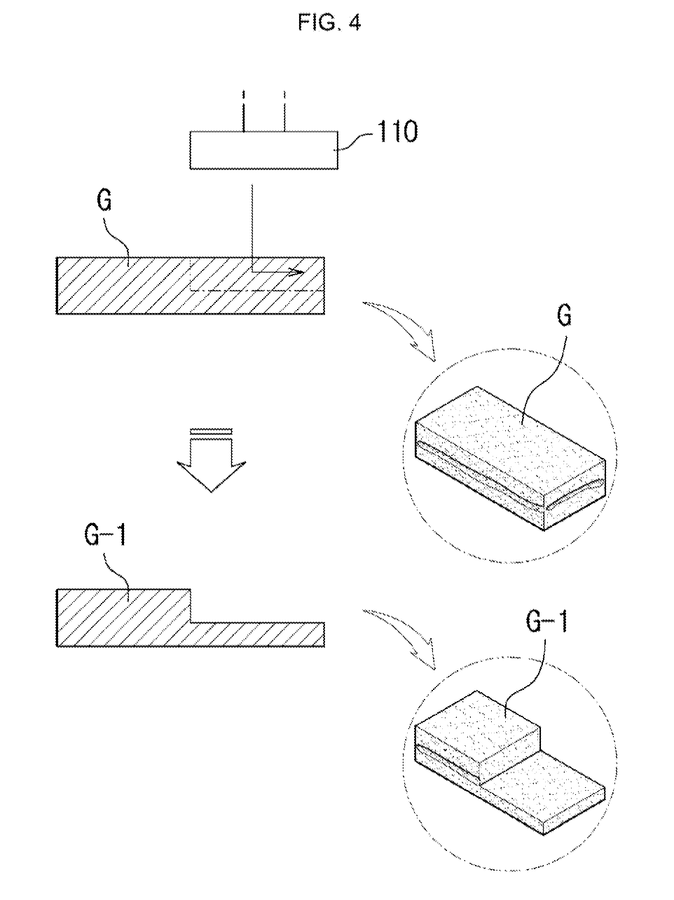

First, as shown in FIG. 4, the preliminary processing step S1 may be a step of cutting the processing material G corresponding to a volume body having a long axis and a short axis into an asymmetric shape which is stepped such that one side thereof is thick and an opposite side of which is thin through the press cutting unit 110 to process the processing material G into the semi-product G-1.

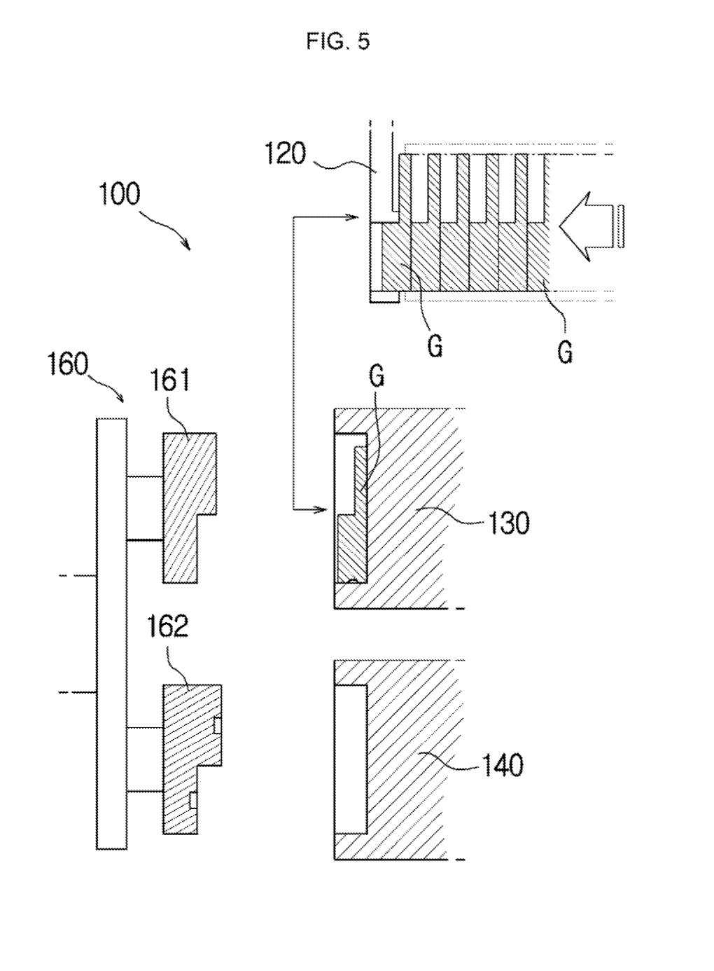

Meanwhile, as shown in FIG. 5, the semi-product introducing step S2 may be a step of gripping a part of the single semi-product G-1 sequentially supplied along a rail and inserting the semi-product G-1 into a forming location of the first processing unit 130 by the pickup unit 120 located at a side of the first processing unit 130.

Then, the pickup unit 120 may be a gripping unit driven through a reciprocation of a piston of a cylinder or a linear reciprocation of a pinion rotated by a motor and a rack gear engaged with the pinion.

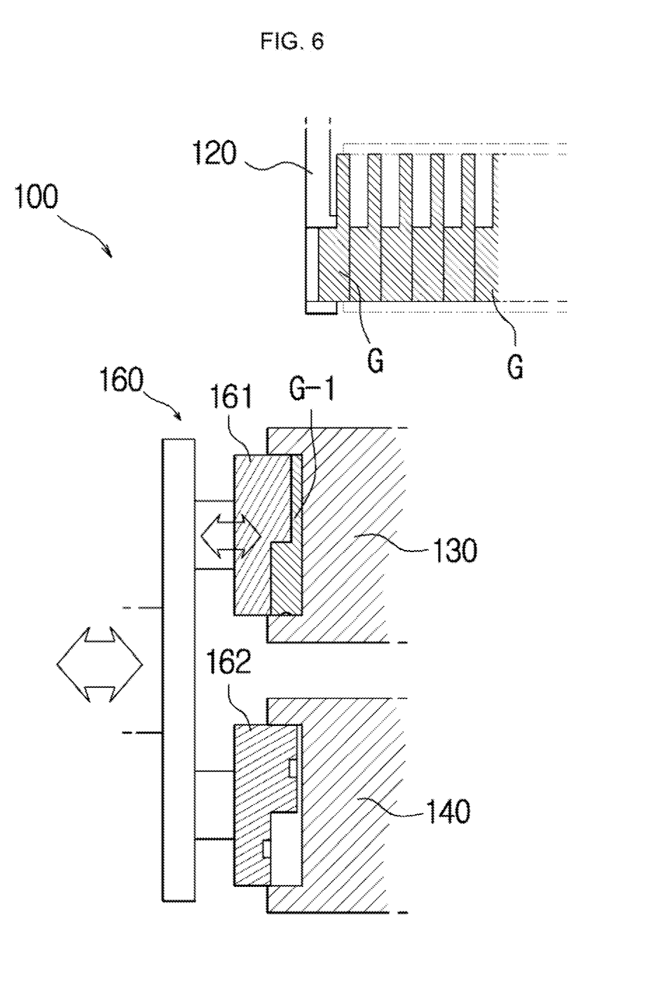

Meanwhile, as shown in FIG. 6, the first forging step S3 may be a step of punching and pressing the processing material G inserted into the fixed mold of the first processing unit 130 by the first punch 161 to forge the processing material G into shapes of a mold provided at a tip end of the first punch 161 and a fixed mold of the first processing unit 130.

Then, the completely formed state may be an asymmetric state in which a volume body part is provided at one side and a plate part is provided at another part.

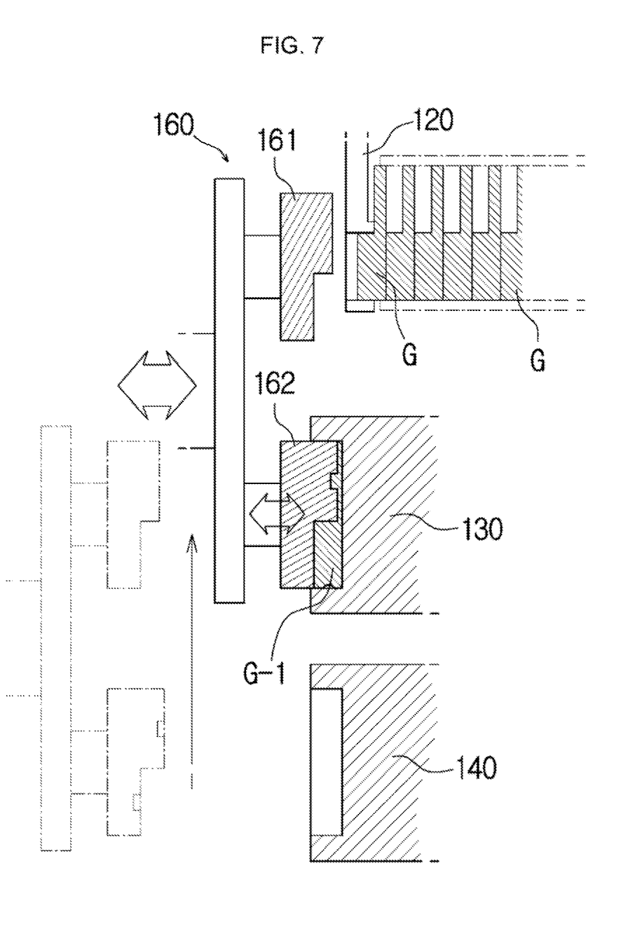

Meanwhile, as shown in FIG. 7, the second forging step S4 may be a step of moving the second punch 162 to a location of the first processing unit 130, and forging the semi-product G-1 forged while being inserted into a fixed mold of the first processing unit 130 into shapes of a mold provided at a tip end of the second punch 162 and a fixed mold of the first processing unit 130 through a punching/pressing operation.

Then, the completely formed state may be a state in which designed structures protrude or are recessed at the volume body part and the plate part, and in the present invention, a pickup gripping member G′ which may be gripped by a feeding unit (not shown) when the semi-product G-1 is fed to another processing unit may protrude from a surface of the plate part.

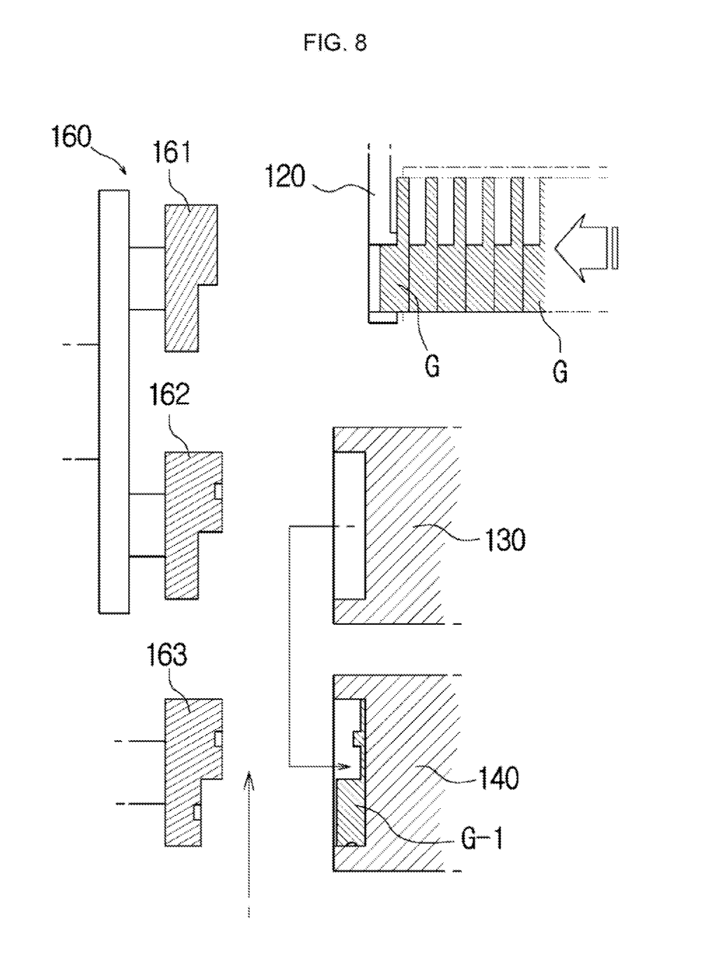

Meanwhile, as shown in FIGS. 8 and 9, the third forging step S5 may be a step of, in a state in which the secondarily forged semi-product G-1 is located in the first processing unit 130 or moved from the first processing unit 130 to the second processing unit 140, moving the third punch 163 to a location of the first processing unit 130 or the second processing unit 140 to punch and press the semi-product G-1 forged while being inserted into a mold provided at a tip end of the third punch 162 a fixed mold of the first processing unit 130 or the second processing unit 140, Then, in the third forging step S5, a cutting line at an edge of the semi-product G1 is pressed in the mold by pressing the semi-product G01 at a pressure stronger than that in the second forging step.

Then, a pressing force in the second forging step may be, for example, 200 ton/cm², and a pressing force in the third forging step may be increased by 15%.

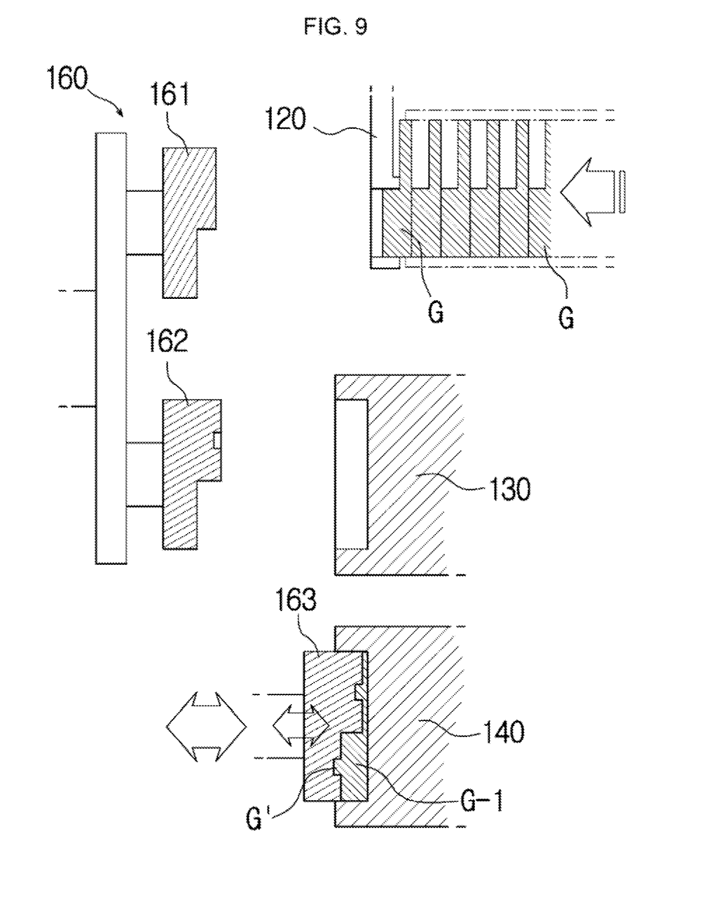

Meanwhile, as shown in FIG. 10, the trimming step S6 is a step of, in a state in which the tertiary forged semi-product G-1 is located in the second processing unit 140 or picked up by a feeing unit to be moved to the third processing unit 150, punching the semi-product G-1 by the cutting/trimming unit 170, removing a pickup gripping member G′ provided at the plate part of the semi-product G-1, and cutting an outer peripheral portion according to a size designed in advance to process the semi-product G-1 into a final product G-2.

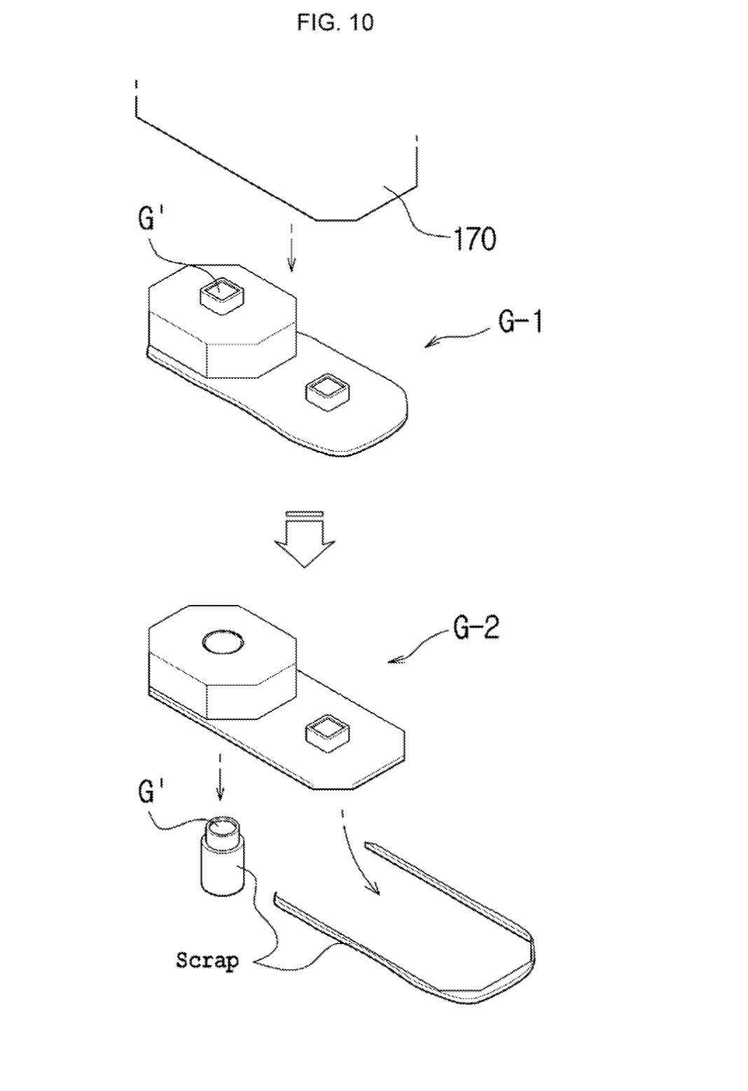

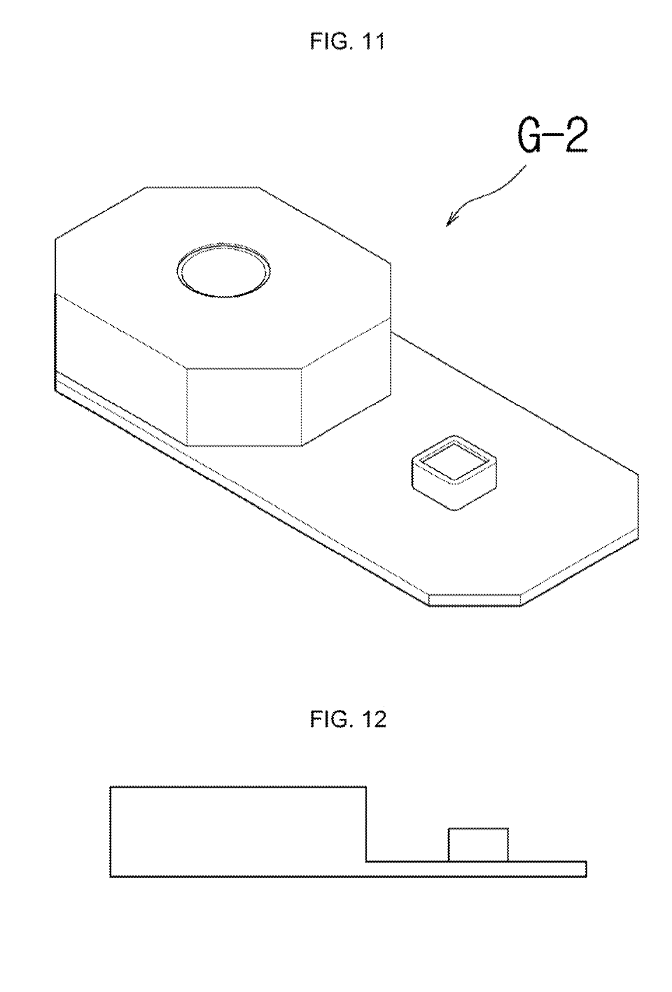

Then, the final product G-2 corresponds to a completely formed state and is shown in FIG. 11, and because a state in which a separate peripheral portion is coupled through insert-molding corresponds to post processing as shown in FIG. 12, it is excluded from the concept of the final product.

Hereinafter, an operation of the present invention will be described.

First, the processing material G corresponding to a volume body having a long axis and a short axis is processed into a semi-product G-1 by individually introducing the processing material G to a part where the press cutting unit 110 is located and cutting the processing material G into an asymmetric shape, for example, a shape stepped such that one side thereof is thick and an opposite side thereof is thin.

In this way, the processed processing material G is sequentially supplied to a location where the pickup unit 120 is present along a feeding rail.

The pickup unit 120 located at one side of the first processing unit 130 grips the processing material G and inserts the processing material G into a forming location of the first processing unit 130.

If the processing material G is inserted into the fixed mold of the first processing unit 130, the first punch 161 punches and presses the processing material G to forge the processing material G into shapes of the mold provided at a tip end of the first punch 161 and the fixed mold of the first processing unit 130.

Then, the shape of the processing material G formed by the fixed mold of the first processing unit 130 and the mold at the tip end of the first punch 161 corresponds to a block body having a volume at one side and a plate shape thinner than the block body at an opposite side, and a pickup gripping member G′ which can be gripped by the feeding unit (not shown) protrudes from a surface of the plate part when the processing material G is fed to another processing unit.

If the semi-product G-1 is forged in the first forging step, the second punch 162 is moved to the location of the first processing unit 130 and the semi-product G-1 is secondarily forged into the shapes of the mold provided at a tip end of the second punch 162 and the fixed mold of the first processing unit 130, by punching and pressing the primarily forged semi-product G-1 while the semi-product G-1 is inserted into the fixed mold of the first processing unit 130.

Then, the semi-product G-1 formed by the fixed mold of the first processing unit 130 and the mold at the tip end of the first punch 161 is shaped such that the shape of the block body having a volume is formed more clearly in the first forging step and the portion formed into the plate shape at an opposite side is expanded more clearly, so that the pickup gripping member G′ is formed more clearly in the first forging step.

In the process, a cutting surface or a cutting line formed at an edge of the semi-product G-1 is pressed and partially removed.

Thereafter, the third forging step S5 may be a step of, in a state in which the secondarily forged semi-product G-1 is located in the first processing unit 130 or moved from the first processing unit 130 to the second processing unit 140, moving the third punch 163 to a location of the first processing unit 130 or the second processing unit 140 to punch and press the semi-product G-1 forged while being inserted into a mold provided at a tip end of the third punch 162 and a fixed mold of the first processing unit 130 or the second processing unit 140.

Then, in the third forging step S5, a cutting surface or a cutting line at an edge of the semi-product G-1 is pressed in the mold by pressing the semi-product G01 at a pressure stronger than that in the second forging step, and accordingly, the shape of the cutting surface or the cutting line is mostly removed.

The semi-product G-1 formed by the fixed mold of the first processing unit 130 or the second processing unit 140 and the mold at the tip end of the third punch 163 is shaped such that the shape of the block body having a volume is formed more clearly in the second forging step and the portion formed into the plate shape at an opposite side is expanded more widely, so that the pickup gripping member G′ is formed more clearly in the second forging step, making it possible to form a product close to a final product G-2.

Finally, in a state in which the tertiary forged semi-product G-1 is located in the second processing unit 140 or the feeding unit is picked up to be moved to the third processing unit 150, the cutting/trimming unit 170 at a tip end thereof having a cutting tool having a size and a shape designed in advance punches the semi-product G-1, so that the pickup gripping member G′ provided at the plate part of the semi-product G-1 is removed and an outer peripheral portion of the semi-product is cut into a final product G-2, making it possible to finish the final product G-2 corresponding to the size of design.

According to the present invention, when a battery terminal plate for an electric vehicle is processed, a single processing material G having a volume body is processed by stages while performing both pressing and forging to manufacture a final product, so that a cutting surface or a cutting line generated in the pressing process is removed and an asymmetric forming operation which is difficult or impossible in the forging process can be allowed.

In particular, while a process of asymmetrically forming a processing material having a big size, for example, of making one side thereof thick and an opposite side thin is impossible in forging, the present invention can achieve it.

The reason why it is impossible to asymmetrically form a processing material in forging, that is, make one side thick and an opposite side thin is that because forging is realized by tapping a processing material, it is difficult to form a precise shape and many inferior products are caused in the forming process when a force is excessively applied to one side.

Although the exemplary embodiments for exemplifying the principle of the present invention have been described and shown, the present invention is not limited to the configurations and operation.

In addition, it will be appreciated by those skilled in the art that the present invention can be variously modified and changed without departing from the spirit of the present invention claimed in the claims.

Therefore, all modifications, changes, and equivalents thereof will be regarded as pertaining to the scope of the present invention.

### DESCRIPTION OF REFERENCE NUMERALS

100: Battery terminal plate manufacturing apparatus
110: Press cutting unit
120: Pickup unit
130: First processing unit
140: Second processing unit
150: Third processing unit
160: Forming unit
161: First punch
162: Second punch
163: Third punch
170: Cutting/trimming unit
G: Processing material
G-1: Semi-product
G-2: Final product
G′: Pickup gripping member

1. A method of manufacturing a battery terminal plate, the method comprising:
a preliminary processing step S1 of primarily pressing a single processing material G corresponding to a volume body into a semi-product G-1 having an asymmetric shape through a press cutting unit 110;
a semi-product introducing step S2 of gripping the semi-product G-1 continuously supplied after being primarily processed and feeding the semi-product G-1 to a first processing unit 130 by a pickup unit 120;
a first forging step S3 of asymmetrically pressing the semi-product G-1 introduced into the first processing unit 130 by a first punch 161 to primarily forge the semi-product G-1 into a volume body part and a plate part;
a second forging step S4 of pressing the semi-product G-1 located in the first processing unit 130 by a second punch 162 performing a pressing operation while interlocking with the first punch 161 to secondarily forge the semi-product G-1 while forming a detailed structure at the volume body part and the plate part;
a third forging step S5 of, in a state in which the secondarily forged semi-product G-1 is located in the first processing unit 130 or is moved from the first processing unit 130 to the second processing unit 140, pressing the semi-product G-1 with a pressure stronger than that in the second forging step by a third punch 163 to tertiary forge the semi-product G-1 such that a cutting surface or a cutting line at an edge of the semi-product G-1 is pressed; and
a trimming step S6 of, in a state in which the semi-product G-1 is located in the second processing unit 140 or moved to the third processing unit 150, punching the semi-product G-1 by a cutting/trimming unit 170 performing an elevation pressing operation to trim the remaining cutting surface or cutting line and an outer peripheral portion according to a design size such that the semi-product G-1 is processed into a final product G-2.

2. The method of claim 1, wherein the preliminary processing step S1 is a step of cutting the processing material G corresponding to a volume body having a long axis and a short axis into an asymmetric shape which is stepped such that one side thereof is thick and an opposite side of which is thin through the press cutting unit 110 to process the processing material G into the semi-product G-1.

3. The method of claim 1, wherein the semi-product introducing step S2 is a step of gripping a part of the single semi-product G-1 sequentially supplied along a rail and inserting the semi-product G-1 into a forming location of the first processing unit 130 by the pickup unit 120 located at a side of the first processing unit 130.

4. The method of claim 1, wherein the first forging step S3 is a step of punching and pressing the processing material G inserted into a fixed mold of the first processing unit 130 by the first punch 161 such that the processing material G is asymmetrically forged into a volume body part at one side and a plate part at another side.

5. The method of claim 1, wherein the second forging step S4 is a step of moving the second punch 162 to a location of the first processing unit 130 and protruding or recessing a structure designed in advance in the volume body part and the plate part through punching and pressing the semi-product G-1 forged while being inserted into a fixed mold of the first processing unit 130.

6. The method of claim 1, wherein the third forging step S5 is a step of, in a state in which the secondarily forged semi-product G-1 is located in the first processing unit 130 or moved from the first processing unit 130 to the second processing unit 140, moving the third punch 163 to a location of the first processing unit 130 or the second processing unit 140 to punch and press the semi-product G-1 forged while being inserted into a fixed mold of the first processing unit 130 or the second processing unit 140 such that the semi-product G-1 is forged while being pressed in a mold so that a cutting surface or a cutting line is partially removed.

7. The method of claim 1, wherein the trimming step S6 is a step of, in a state in which the formed semi-product G-1 is located in the second processing unit 140 or picked up by a feeding unit to be moved to the third processing unit 150, pressing and punching the semi-product G-1 by the cutting/trimming unit 170, removing a pickup gripping member G′ provided at the plate part of the semi-product G-1, and removing a cutting surface or a cutting line and cutting an outer peripheral portion according to a size designed in advance to process the semi-product G-1 into a final product G-2.
